(19) United States
(12) Patent Application Publication
(10) Pub. No.: US 2016/0014674 A1
(43) Pub. Date: Jan. 14, 2016

(54) METHOD FOR LOCATION BASED ACCESS CONTROL IN WIRELESS COMMUNICATION SYSTEM AND APPARATUS THEREFOR

(71) Applicant: LG ELECTRONICS INC., Seoul (KR)

(72) Inventors: Hongbeom AHN, Seoul (KR); Seungkyu PARK, Seoul (KR); Seongyun KIM, Seoul (KR); Seungmyeong JEONG, Seoul (KR); Heedong CHOI, Seoul (KR)

(73) Assignee: LG ELECTRONICS INC., Seoul (KR)

(21) Appl. No.: 14/721,714

(22) Filed: May 26, 2015

Related U.S. Application Data
(60) Provisional application No. 62/022,664, filed on Jul. 10, 2014.
(60) Provisional application No. 62/026,645, filed on Jul. 19, 2014.

(51) Int. Cl. H04W 48/04; H04W 68/00; H04W 4/00; H04L 29/12

(52) U.S. Cl. CPC H04W 48/04; H04L 61/2007; H04W 68/005; H04W 4/005

(57) ABSTRACT

A method for location based access control in a wireless communication system is disclosed. The method comprises receiving, from an originating device, a request for access to a specific resource associated with location constraints, the location constraints being related to circular description or country description, checking whether location information of the originating device is present, acquiring the location information of the originating device according to type of the location constraints when the location information of the originating device is not present, and performing access control based on the acquired location information.

This application claims the benefit of U.S. Provisional Application Nos. 62/022,664, filed on Jul. 10, 2014 and 62/026,645, filed on Jul. 19, 2014, which are hereby incorporated by reference as if fully set forth herein.

### BACKGROUND OF THE INVENTION

1. Field of the Invention

The present invention relates to a method for location based access control in a wireless communication system and an apparatus therefor.

2. Discussion of the Related Art

With the advent of ubiquitous era, M2M (Machine to Machine) communication technology is spotlighted. M2M communication technology is being studied by many standard development organizations (SDOs) such as TIA, ATIS, ETSI and oneM2M. In M2M environments, communication between M2M related applications (network application/gateway application/device application) is performed and an M2M server part (e.g. common service entity (CSE)) may differ from a network application operating entity. Accordingly, access to resources present in a different entity is mandatory.

To prevent indiscriminate access to resources, access control is needed. Particularly, an access control method based on the location of an access requester or requesting device is required.

Accordingly, the present invention provides a method capable of efficiently providing location based access control.

### SUMMARY OF THE INVENTION

Accordingly, the present invention is directed to a method for location based access to a specific resource in a wireless communication system that substantially obviates one or more problems due to limitations and disadvantages of the related art.

The technical problems solved by the present invention are not limited to the above technical problems and those skilled in the art may understand other technical problems from the following description.

According to an embodiment of the present invention, there is provided a method for location based access control in a wireless communication system, the method including: receiving, from an originating device, a request for access to a specific resource associated with location constraints, the location constraints being related to circular description or country description; checking whether location information of the originating device is present; acquiring the location information of the originating device according to type of the location constraints when the location information of the originating device is not present; and performing access control based on the acquired location information, wherein the acquiring of the location information of the originating device comprises: acquiring the location information of the originating device by subscribing to a location notification service toward a location server when the location constraints are related to the circular description; determining whether country in which the originating device is located is distinguished using an Internet protocol (IP) address of the originating device when the location constraints are related to the country description; and acquiring the location information of the originating device by requesting the location server to provide the location information of the originating device when the country is not distinguished using the IP address of the originating device.

Alternatively or additionally, the acquiring the location information of the originating device by subscribing to the location notification service toward the location server may include: setting a value corresponding to the circular description in a resource related to the location notification service; and receiving information on the location of the originating device according to the location notification service.

Alternatively or additionally, the acquiring the location information of the originating device by subscribing to the location notification service toward the location server may include receiving a notification of location change of the originating device from the location server when the originating device enters or leaves a region corresponding to the circular description.

Alternatively or additionally, the performing of access control based on the acquired location information may include: checking whether the acquired location information satisfies the location constraints; and transmitting a response to the request for access according to a result of the checking to the originating device.

Alternatively or additionally, the location constraints may be included in a specific parameter in <accessControlPolicy> resource associated with the specific resource.

According to an embodiment of the present invention, there is provided an apparatus configured to perform location based access control in a wireless communication system, including: a radio frequency (RF) unit; and a processor configured to control the RF unit, wherein the processor is configured: to receive, from an originating device, a request for access to a specific resource associated with location constraints, the location constraints being related to circular description or country description; to check whether location information of the originating device is present; to acquire the location information of the originating device according to type of the location constraints when the location information of the originating device is not present; and to perform access control based on the acquired location information, wherein the process is configured: to acquire the location information of the originating device by subscribing to a location notification service toward a location server when the location constraints are related to the circular description; to determine whether country in which the originating device is located is distinguished using an Internet protocol (IP) address of the originating device when the location constraints are related to the country description: and to acquire the location information of the originating device by requesting the location server to provide the location information of the originating device when the country is not distinguished using the IP address of the originating device.

Alternatively or additionally, the processor may be configured to set a value corresponding to the circular description in a resource related to the location notification service and to receive information on the location of the originating device according to the location notification service to acquire the location information of the originating device by subscribing to the location notification service toward the location server.

Alternatively or additionally, to acquire of the location information of the originating device by subscribing to the location notification service of the location server, the processor may be configured to receive a notification of location change of the originating device from the location server when the originating device enters or leaves a region corresponding to the circular description to acquire the location information of the originating device by subscribing to the location notification service toward the location server.

Alternatively or additionally, the processor may be configured to determine whether the acquired location information satisfies the location constraints and to transmit a response to the request for access according to a result of the checking to the originating device to perform access control based on the acquired location information.

Alternatively or additionally, the location constraints may be included in a specific parameter in <accessControlPolicy> resource associated with the specific resource.

The aforementioned technical solutions are merely parts of embodiments of the present invention and various embodiments in which the technical features of the present invention are reflected can be derived and understood by a person skilled in the art on the basis of the following detailed description of the present invention.

According to an embodiment of the present invention, it is possible to improve efficiency of location based access to resources in a wireless communication system.

The effects of the present invention are not limited to the above-described effects and other effects which are not described herein will become apparent to those skilled in the art from the following description.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a functional structure in an M2M communication system;

FIG. 2 illustrates a configuration supported by an M2M communication system on the basis of the M2M functional structure;

FIG. 3 illustrates common service functions provided by an M2M communication system;

FIG. 4 illustrates structures of resources present in an M2M application service node and an M2M infrastructure node;

FIG. 5 illustrates structures of resources present in an M2M application service node (e.g. M2M device) and an M2M infrastructure node;

FIG. 6 illustrates a conventional location based access control method;

FIG. 7 illustrates a conventional location based access control method;

FIG. 8 illustrates a location based access control method according to an embodiment of the present invention; and

FIG. 9 is a block diagram of an apparatus for implementing embodiments of the present invention.

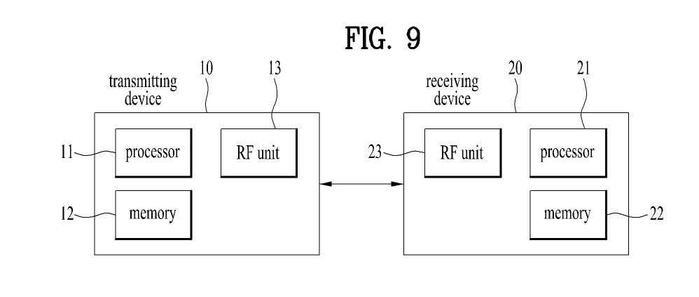

### DETAILED DESCRIPTION OF THE INVENTION

Reference will now be made in detail to the preferred embodiments of the present invention, examples of which are illustrated in the accompanying drawings. The following detailed description of the invention includes details to aid in full understanding of the present invention. Those skilled in the art will appreciate that the present invention can be implemented without these details.

In some cases, to prevent the concept of the present invention from being obscured, structures and apparatuses of the known art will be omitted, or will be shown in the form of a block diagram based on main functions of each structure and apparatus. In addition, wherever possible, the same reference numbers will be used throughout the drawings and the specification to refer to the same or like parts.

In the present disclosure, devices for device-to-device communication, that is, M2M devices, may be fixed or mobile and include devices which communicate with a server for device-to-device communication, that is, an M2M server to transmit/receive user data and/or various types of control information. The M2M devices may be referred to as terminal equipment, mobile stations (MSs), mobile terminals (MTs), user terminals (UTs), subscriber stations (SSs), wireless devices, personal digital assistants (PDA), wireless modems, handheld devices and the like. In the present invention, the M2M server refers to a fixed station which communicates with M2M devices and/or other M2M servers, and exchanges various types of data and control information with M2M devices and/or other M2M servers by communicating with the M2M devices and/or other M2M servers. Further, in the present disclosure, a M2M gateway refers to a device acting a role of a connection point entering from one network into another network when a network to which the M2M device connected and a network to which the M2M server connected are different.

Additionally, in the present disclosure, the term “entity” refers to a hardware such as M2M devices, M2M gateways and M2M servers, or a software component of M2M application layer and M2M (common) service layer as described below.

A description will be given of technology associated with the present invention.

M2M Applications

These are applications that execute service logic and use a common service entity (CSE) accessible through an open interface. The M2M applications can be installed in an M2M device, an M2M gateway or an M2M server.

M2M Service

This is a set of functions that can be used by the M2M CSE through standardized interfaces.

oneM2M defines a common M2M service framework (or service platform, CSE or the like) for various M2M applications (or application entities (AEs)). M2M applications can be considered as software implementing service logic such as e-Health, City Automation, Connected Consumer and Automotive. The oneM2M service framework includes functions commonly necessary to implement various M2M applications. Accordingly, it is possible to easily implement various M2M applications using the oneM2M service framework without configuring frameworks necessary for the respective M2M applications. This can integrate M2M markets currently divided into many M2M verticals, such as smart building, smart grid, e-Heath, transportation and security, and thus remarkable growth of the M2M markets is expected.

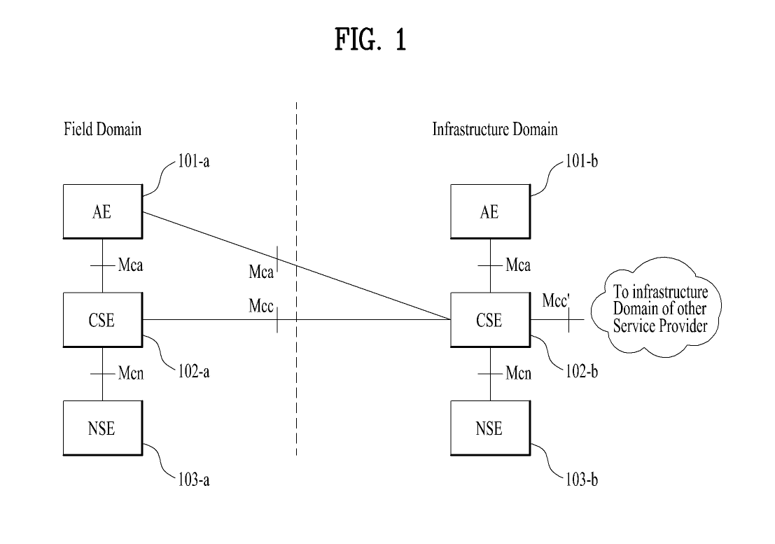

FIG. 1 illustrates the architecture of an M2M communication system. Each entity will now be described.

Application entity (AR, 101): Application entity provides application logic for end-to-end M2M solutions. Examples of the application entity include fleet tracking application, remote blood sugar monitoring application, remote power metering and controlling application.

Common service entity (CSE, 102): CSE comprises the set of “service functions” that are common to M2M environments and specified by oneM2M. Such service functions are exposed to AEs and other CSEs through reference points X and Y and used by the AEs and other CSEs. The reference point Z is used for accessing underlying network service entities.

Examples of the service functions provided by the CSE include data management, device management, M2M subscription management and location service. These functions can be logically classified into common service functions (CSFs). Some CSFs in the CSE are mandatory and some may be optional. Further, some functions in the CSFs are mandatory and some functions may be optional (e.g. some of application software installation, firmware update, logging and monitoring functions in “device management” CSF are mandatory functions and some are optional functions.)

Underlying network service entity (NSE, 103): provides services to the CSEs. Examples of such services include device management, location services and device triggering. No particular organization of the NSEs is assumed. Note: underlying networks provide data transport services between entities in the oneM2M system. Such data transport services are not included in the NSE.

The reference points shown in FIG. 1 will now be described.

Mca Reference Point

This is the reference point between an AE and a CSE. The Mca reference point allows the CSE to communicate with the AE such that the AE can use the services provided by the CSE.

The services provided through the Mca reference point are dependent on the functionality supported by the CSE. The AE and the CSE may or may not be co-located within the same physical entity.

Mcc Reference Point

This is the reference point between two CSEs. The Mcc reference point allows a CSE to use the services of another CSE in order to fulfill needed functionality. Accordingly, the Mcc reference point between two CSEs is supported over different M2M physical entities. The services offered via the Mcc reference point are dependent on the functionality supported by the CSEs.

Mcn Reference Point

This is the reference point between a CSE and an NSE. The Mcn reference point allows a CSE to use the services (other than transport and connectivity services) provided by the NSE in order to fulfill the needed functionality. It means services other than simple service such as transport and connectivity, for example, services such as device triggering, small data transmission and positioning.

Mcc′ Reference Point

This is the reference point is used for communication between CSEs respectively belongs to different M2M service providers. Mcc′ references point is similar to Mcc reference point in respect of connecting CSEs each other, but Mcc′ reference point expands Mcc reference point to different M2M service providers while Mcc reference point is limited to communication in a single M2M service provider.

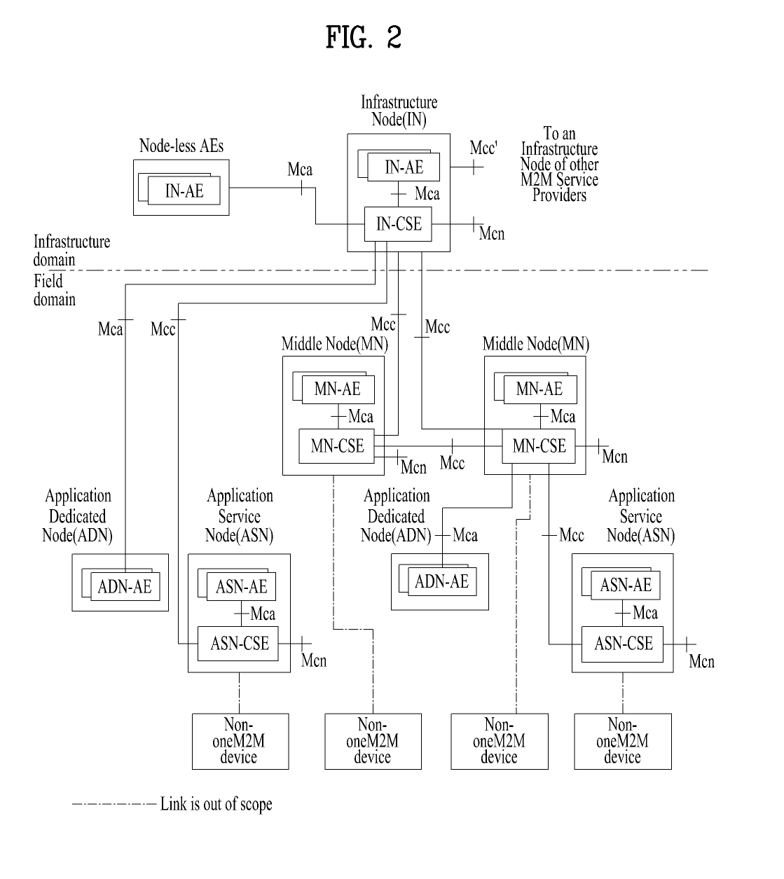

FIG. 2 illustrates compositions supported by M2M communication system based on the architecture. The M2M communication system may support more various compositions without being limited to the illustrated compositions. A concept, which is called to node, important for understand the illustrated compositions will be explained.

Application Dedicated Node (ADN): An application dedicated node is a node that contains at least one M2M application and does not contain a CSE. The ADN can communicate over an Mca reference point with one middle node or one infrastructure node. The ADN can be present in an M2M device.

Application Service Node (ASN): An application service node is a node that contains at least one CSE and has at least one M2M application. The ASN can communicate over a Mcc reference point with one middle node or one infrastructure node. The ASN can be present in an M2M device.

Middle Node (MN): A middle node is a node that contains at least one CSE and may contain M2M applications. The middle node communicates over a Mcc references point with at least two nodes belonging to the following different category:
one or more ASNs;
one or more middle nodes (MNs); and
one infrastructure structure.

The MN can be connected with the ADN through an Mca reference point. The MN can be present in an M2M gateway.

Infrastructure Node (IN): An infrastructure node is a node that contains one CSE and may contain application entities (AEs). The IN can be present in M2M server.

The IN communicates over a Mcc reference point with either:
one or more middle nodes; and/or
one or more application service nodes.

The IN may communicate with one or more ADNs over one or more Mca reference points.

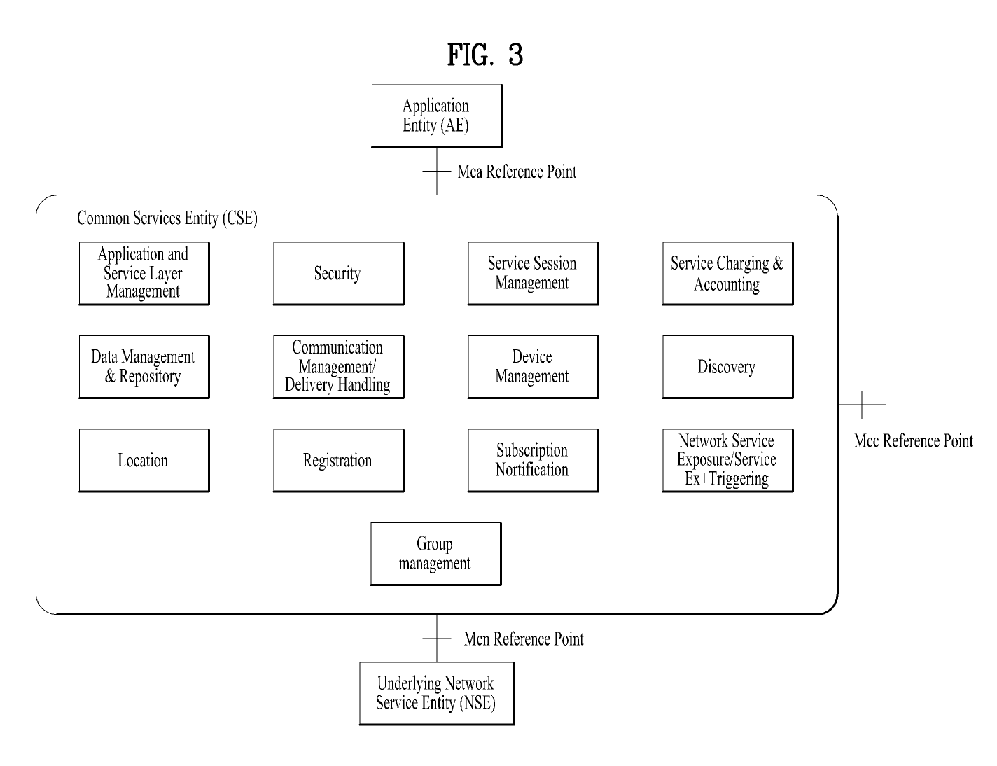

FIG. 3 illustrates M2M service functions in the M2M communication system.

M2M service functions (i.e. common service functions) provided by the oneM2M service framework include “Communication Management and Delivery Handling”, “Data Management and Repository”, “Device Management”, “Discovery”, “Group Management”, “Addressing and Identification”, “location”, “Network Service Exposure, Service Execution and Triggering”, “Registration”, “Security”, “Service Charging and Accounting”, “Session Management” and “Subscription and Notification.”, as shown in FIG. 3.

A brief description will be given of each M2M service function.

Communication Management and Delivery Handling (CMDH): this provides communications with other CSEs, AEs and NSEs and delivers messages.

Data Management and Repository (DMR): this enables M2M applications to exchange and share data.

Device Management (DMG): this manages M2M devices/gateways. Specifically, the device management function includes installation and setting of applications, determination of set values, firmware update, logging, monitoring, diagnostics, topology management, etc.

Discovery (DIS): this discovers resources and information based on conditions.

Group Management (GMG): this processes a request related to a group that may be generated by grouping resources, M2M devices or gateways.

Addressing and Identification (AID): this identifies and addresses physical or logical resources.

Location (LOC): this enables M2M applications to obtain position information of an M2M device or gateway.

Network Service Exposure, Service Execution and Triggering (NSE): this enables communication of an underlying network and use of functions provided by the underlying network.

Registration (REG): this handles registration of an M2M application or another CSE with a specific CSE. Registration is performed in order to use M2M service functions of the specific CSE.

Security (SEC): this performs handling of sensitive data such as a security key, association establishment, authentication, authorization, identity protection, etc.

Service Charging and Accounting (SCA): this provides a charging function to CSEs.

Session Management (SM): this manages an M2M session for end-to-end communication.

Subscription and Notification (SUB): this notifies change of a specific resource when the change of the specific resource is subscribed.

The M2M service functions are provided through CSE, and AE (or, M2M applications) may use through Mca reference point, or other CSE may use the M2M service functions through Mcc reference point. Also, the M2M service functions may be operated synchronized with underlying network (or underlying network service entity (NSE) such as 3GPP, 3GPP2, Wi-Fi, Bluetooth).

All oneM2M devices/gateways/infrastructures do not have higher functions and may have mandatory functions and some optional functions from among the corresponding functions.

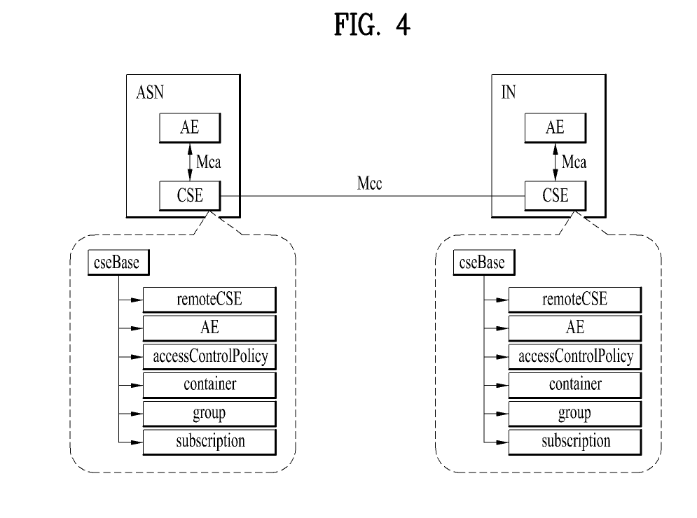

FIG. 4 illustrates structures of resources present in an M2M application service node and an M2M infrastructure node.

The M2M architecture defines various resources. M2M services for registering applications and reading sensor values can be performed by operating the resources. The resources are configured in one tree structure and may be logically connected to the CSE or stored in the CSE to be stored in M2M devices, M2M gateways, network domains and the like. Accordingly, the CSE can be referred to as an entity that manages resources. The resources have a <cseBase> as a tree root. Representative resources are described below.

<cseBase> resource: this is a root resource of oneM2M resources configured in a tree and includes all other resources.

<remoteCSE> resource: this belongs to <cseBase> resource and includes information on other CSE being connected or registered to corresponding CSE.

<AE> resource: this is a resource that is lower than <cseBase> or <remoteCSE> resource, and stores information on applications registered (connected) with the corresponding CSE when present under <cseBase> resource, and stores information on applications registered with other CSEs (in the name of CSE) when present under <remoteCSE> resource.

<accessControlPolicy> resource: this stores information associated with access rights to specific resources. Authentication is performed using access rights information included in this resource.

<containetr> resource: this is a resource that is lower than containers and stores data per CSE or AE.

<group> resource: this is a resource that is lower than groups and provides a function of grouping a plurality of resources and simultaneously processing the grouped resources.

<subscription> resource: this is a resource that is lower than subscriptions and executes a function of announcing a state change such as a resource value change through notification.

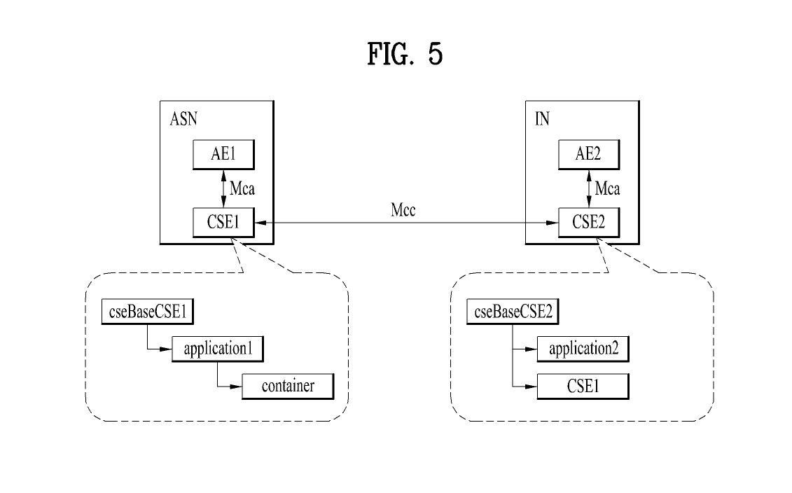

FIG. 5 illustrates structures of resources present in an M2M application service node (e.g. M2M device) and an M2M infrastructure node.

A description will be given of a method by which an AE (application 2) registered with the M2M infrastructure node reads a value of a sensor of the M2M device. The sensor refers to a physical device, in general. An AE (application 1) present in the M2M device reads a value from the sensor and stores the read value in the form of a container resource in a CSE (CSE 1) in which the AE (application 1) has registered. To this end, the AE present in the M2M device needs to be pre-registered with the CSE present in the M2M device. Upon completion of registration, registered M2M application related information is stored in the form of cseBaseCSE1/application1 resource, as shown in FIG. 5.

When the sensor value is stored, by the AE present in the M2M device, in a container resource lower than the cseBaseCSE1/application1 resource, the AE registered with the infrastructure node can access the corresponding value. To enable access, the AE registered with the infrastructure node also needs to be registered with a CSE (CSE 2) of the infrastructure node. Registration of the AE is performed by storing information about application 2 in cseBaseCSE2/application2 resource as application 1 is registered with CSE 1. Application 1 communicates with application 2 via CSE 1 and CSE 2 instead of directly communicating with application 2. To this end, CSE 1 needs to be pre-registered with CSE 2. When CSE 1 registers with CSE 2, CSE 1 related information (e.g. Link) is stored in the form of <remoteCSE> resource lower than cseBaseCSE2 resource. That is, <remoteCSE> provides a CSE type, access address (IP address and the like), CSE ID, and reachability information about the registered CSE.

Resource discovery refers to a process of discovering resources present in a remote CSE. Resource discovery is performed through a retrieve request and the retrieve request for resource discovery includes the following.

<startURI>: this indicates a URI. The URI can be used to limit the range of resources to be discovered. If <startURI> indicates a resource root <cseBase>, resource discovery is performed on all resources of a receiver that has received the retrieve request. The receiver performs resource discovery only on a resource indicated by <startURI> and a lower resource thereof.

filterCriteria: this information describes information related to a resource to be discovered. The receiver searches the resources within a discovery range defined by <startURI> for a resource that satisfies filterCriteria and transmits the resource to a requester of the corresponding request.

A method for setting a location information acquisition scheme in an M2M system can use <locationPolicy> resource.

The <locationPolicy> resource indicates a method for acquiring and managing geographical location information of an M2M node. Actual location information is stored in <contentInstance> resource, which is a child resource of the <container> resource, and the <container> resource includes locationID attribute having the URI of the <locationPolicy> resource. A CSE can acquire location information on the basis of attributes defined under the <locationPolicy> resource and store the location information in the target <container> resource.

Methods for acquiring location information of a node depend on LocationSource attributes. Description will be given of methods for acquiring location information.
Network-based method: A CSE instead of an AE acquires location information of a target node from an underlying network.
Device-based method: An ASN has modules or techniques (e.g. GPS) capable of measuring location and measures the location thereof.
Sharing-based method: An ADN is not connected to a GPS or an underlying network. Location information of the ADN can be acquired from an ASN or MN.

Here, geographical location information can include latitude and longitude. The <locationPolicy> resource is described through the following table.

TABLE 1

| | | RW/ | | |
|---|---|---|---|---|
| Attribute Name of | | RO/ | | <locationPolicyAnnc> |
| <locationPolicy> | Multiplicity | WO | Description | Attributes |
| resourceType | 1 | RO | Resource Type. This Write Once | NA |
| | | | (at creation time then cannot be | |
| | | | changed) resourceType attribute | |
| | | | identifies the type of resources. | |
| | | | Each resource shall have a | |
| | | | resourceType attribute. | |
| resourceID | 1 | WO | This attribute is an identifier for | MA |
| | | | resource that is used for ‘non- | |
| | | | hierarchical URI method’ or ‘IDs | |
| | | | based method’ cases. | |
| | | | This attribute shall be provided by | |
| | | | the Hosting CSE when it accepts a | |
| | | | resource creation procedure. The | |
| | | | Hosting CSE shall assign a | |
| | | | resourceID which is unique in the | |
| | | | CSE. | |
| parentID | 1 | RO | The system shall assign the value | NA |
| | | | to this attribute according to the | |
| | | | parameters given in the CREATE | |
| | | | Request. | |
| | | | It establishes the parent-child | |
| | | | relationship by identification of | |
| | | | the parent of this child resource. | |
| | | | Such identifier shall use the non- | |
| | | | hierarchical URI representation. | |
| | | | For example, an AE resource with | |
| | | | the identifier “myAE1” which has | |
| | | | been created under the resource | |
| | | | “ . . . //example.com/oneM2M/myCSE”, | |
| | | | the value of the parentID | |
| | | | attribute will contain | |
| | | | “ . . . //parentID”. | |
| expirationTime | 1 | RW | Time/date after which the | MA |
| | | | resource will be deleted by the | |
| | | | hosting CSE. This attribute can be | |
| | | | provided by the Originator, and in | |
| | | | such a case it will be regarded as a | |
| | | | hint to the hosting CSE on the | |
| | | | lifetime of the resource. The | |
| | | | hosting CSE can however decide | |
| | | | on the real expirationTime. If the | |
| | | | hosting CSE decides to change | |
| | | | the expirationTime attribute | |
| | | | value, this is communicated back | |
| | | | to the Originator. | |
| | | | The lifetime of the resource can | |
| | | | be extended by providing a new | |
| | | | value for this attribute in an | |
| | | | UPDATE operation. Or by | |
| | | | deleting the attribute value, e.g. | |
| | | | by not providing the attribute | |
| | | | when doing a full UPDATE, in | |
| | | | which case the hosting CSE can | |
| | | | decide on a new value. | |
| | | | This attribute shall be mandatory. | |
| | | | If the Originator does not provide | |
| | | | a value in the CREATE operation | |
| | | | the system shall assign an | |
| | | | appropriate value depending on its | |
| | | | local policies and/or M2M service | |
| | | | subscription agreements. | |
| accessControlPolicyIDs | 0 . . . 1 (L) | RW | The attribute contains a list of | MA |
| | | | identifiers (either an ID or a URI | |
| | | | depending if it is a local resource | |
| | | | or not) of an | |
| | | | <accessControlPolicy> resource. | |
| | | | The privileges defined in the | |
| | | | <accessControlPolicy> resource | |
| | | | that are referenced determine who | |
| | | | is allowed to access the resource | |
| | | | containing this attribute for a | |
| | | | specific purpose (e.g. Retrieve, | |
| | | | Update, Delete, etc.). | |
| | | | If a resource type does not have | |
| | | | an accessControlPolicyIDs | |
| | | | attribute definition, then the | |
| | | | accessControlPolicy for that | |
| | | | resource is governed in a different | |
| | | | way, for example, the | |
| | | | accessControlPolicy associated | |
| | | | with the parent may apply to a | |
| | | | child resource that does not have | |
| | | | an accessControlPolicyIDs | |
| | | | attribute definition, or the | |
| | | | privileges for access are fixed by | |
| | | | the system. Refer to the | |
| | | | corresponding resourceType and | |
| | | | procedures to see how | |
| | | | permissions are handled in such | |
| | | | cases. | |
| | | | If a resource type does have an | |
| | | | accessControlPolicyIDs attribute | |
| | | | definition, but the (optional) | |
| | | | accessControlPolicyIDs attribute | |
| | | | is not set, or it is set to a value | |
| | | | that does not correspond to a | |
| | | | valid, existing | |
| | | | <accessControlPolicy> resource, | |
| | | | or it refers to an | |
| | | | <accessControlPolicy> resource | |
| | | | that is not reachable (e.g. because | |
| | | | it is located on a remote CSE that | |
| | | | is offline or not reachable), then | |
| | | | the system default access | |
| | | | permissions shall apply. | |
| | | | All resources are accessible only | |
| | | | if the privileges from the Access | |
| | | | Control Policy grants it, therefore | |
| | | | all resources shall have an | |
| | | | associated | |
| | | | AccessControlPolicyIDs attribute, | |
| | | | either explicitly (setting the | |
| | | | attribute in the resource itself) or | |
| | | | implicitly (either by using the | |
| | | | parent privileges or the system | |
| | | | defaults). Which means that the | |
| | | | system shall provide a default | |
| | | | access privileges in case that the | |
| | | | Originator does not provide a | |
| | | | specific AccessControlPolicyIDs | |
| | | | during the creation of the | |
| | | | resource, Default access grants | |
| | | | the configures privileges to the | |
| | | | originator (e.g. depending on the | |
| | | | prefix of URI of the resource). | |
| | | | This attribute is absent from the | |
| | | | resource in some cases, especially | |
| | | | if the resource shall have the same | |
| | | | privileges of the parent resource; | |
| | | | such an attribute is therefore not | |
| | | | needed. | |
| | | | To update this attribute, a Hosting | |
| | | | CSE shall check whether an | |
| | | | Originator has Update permission | |
| | | | in any selfPrivileges of the | |
| | | | <accessControlPolicy> resources | |
| | | | which this attribute originally | |
| | | | indicates. | |
| creationTime | 1 | RO | Time/date of creation of the | NA |
| | | | resource. | |
| | | | This attribute is mandatory for all | |
| | | | resources and the value is | |
| | | | assigned by the system at the time | |
| | | | when the resource is locally | |
| | | | created. Such an attribute cannot | |
| | | | be changed. | |
| lastModifiedTime | 1 | RO | Last modification time/date of the | NA |
| | | | resource. | |
| | | | This attribute shall be mandatory | |
| | | | and its value is assigned | |
| | | | automatically by the system each | |
| | | | time that the addressed target | |
| | | | resource is modified by means of | |
| | | | the UPDATE operation. | |
| labels | 0 . . . 1 | RW | Tokens used as keys for | MA |
| | | | discovering resources. | |
| | | | This attribute is optional and if | |
| | | | not present it means that the | |
| | | | resource cannot be found by | |
| | | | means of discovery procedure | |
| | | | which uses labels as key | |
| | | | parameter of the discovery. | |
| announceTo | 1 | RW | This attribute may be included in | NA |
| | | | a CREATE or UPDATE Request | |
| | | | in which case it contains a list of | |
| | | | URIs/CSE-IDs which the resource | |
| | | | being created/updated shall be | |
| | | | announced to. | |
| | | | This attribute shall only be | |
| | | | present on the original resource if | |
| | | | it has been successfully | |
| | | | announced to other CSEs. This | |
| | | | attribute maintains the list of | |
| | | | URIs to the successfully | |
| | | | announced resources. Updates on | |
| | | | this attribute will trigger new | |
| | | | resource announcement or de- | |
| | | | announcement. | |
| announcedAttribute | 1 | RW | This attributes shall only be | NA |
| | | | present on the original resource if | |
| | | | some Optional Announced (OA) | |
| | | | type attributes have been | |
| | | | announced to other CSEs. This | |
| | | | attribute maintains the list of the | |
| | | | announced Optional Attributes | |
| | | | (OA type attributes) in the | |
| | | | original resource. Updates to this | |
| | | | attribute will trigger new attribute | |
| | | | announcement if a new attribute is | |
| | | | added or de-announcement if the | |
| | | | existing attribute is removed. | |
| locationSource | 1 | RW | Indicates the source of location | OA |
| | | | information | |
| | | | Network Based | |
| | | | Device Based | |
| | | | Sharing Based | |
| locationUpdatePeriod | 0 . . . 1 | RW | Indicates the period for updating | OA |
| | | | location information. If the value | |
| | | | is marked ‘0’ or not defined, | |
| | | | location information is updated | |
| | | | only when a retrieval request is | |
| | | | triggered. | |
| locationTargetId | 0 . . . 1 | RW | The identifier to be used for | OA |
| | | | retrieving the location information | |
| | | | of a remote Node and this | |
| | | | attribute is only used in the case | |
| | | | that location information is | |
| | | | provided by a location server. | |
| locationServer | 0 . . . 1 | RW | Indicates the identity of the | OA |
| | | | location server. This attribute is | |
| | | | only used in that case location | |
| | | | information is provided by a | |
| | | | location server. | |
| locationContainerID | 0 . . . 1 | RO | A URI of the <container> | OA |
| | | | resource where the actual location | |
| | | | information of a M2M Node is | |
| | | | stored. | |
| locationContainerName | 0 . . . 1 | RW | A Name of the <container> | OA |
| | | | resource where the actual location | |
| | | | information of a M2M Node is | |
| | | | stored. If it is not assigned, the | |
| | | | Hosting CSE automatically | |
| | | | assigns a name of the resource. | |
| | | | Note: The created <container> | |
| | | | resource related to this policy | |
| | | | shall be stored only in the Hosting | |
| | | | CSE. | |
| locationStatus | 1 | RO | Contains the information on the | OA |
| | | | current status of the location | |
| | | | request, (e.g., location server | |
| | | | fault) | |
| | | | This Status can be described as | |
| | | | 1—Location Acquired | |
| | | | 2—Location Acquisition Failed | |
| | | | (Server) | |
| | | | 3—Location Acquisition Failed | |
| | | | (Access Deny) | |
| | | | 4—Location for Access Control | |
| | | | 5—Location is updated | |

The <locationPolicy> resource indicates a method for acquiring and managing geographical location information of an M2M device. The <locationPolicy> resource is used as a resource for storing the method for acquiring and managing location information rather than being used to store the location information. Actual location information is stored in the <instance> resource which is a child resource of the <container> resource. The <container> resource can have attribute information (e.g. locationID) that has the URI of the <locationPolicy> resource as linkage. The location common service function (LOC CSF) (refer to FIG. 3) can acquire location information on the basis of attributes defined under the <locationPolicy> resource and store the location information in target <container>.

Table 1 shows attributes related to the <locationPolicy> resource. In Table 1, R/W indicates permission of read/write of the corresponding attribute and may correspond to one of READ/WRITE (RW), READ ONLY (RO) and WRITE ONLY (WO). In Table 1, multiplicity indicates the number of times of generation of the corresponding attribute in the <locationPolicy> resource. Accordingly, when multiplicity is 1, the corresponding attribute is mandatorily included once in the <locationPolicy> resource. When multiplicity is 1 . . . n, the corresponding attribute is mandatorily included once or more in the <locationPolicy> resource. The corresponding attribute is optionally included once or less in the <locationPolicy> resource when multiplicity is 0 . . . 1 and optionally included once or more in the <locationPolicy> resource when multiplicity is 0 . . . n. Table 1 is exemplary and attributes of the <locationPolicy> resource may be configured differently from those shown in Table 1.

The <locationPolicy> resource can be handled using a request/response method. Accordingly, an AE can transmit a generation request message to a hosting CSE in order to generate the <locationPolicy> resource in the hosting CSE, transmit a retrieve request message to the hosting CSE in order to retrieve the <locationPolicy> resource, transmit an update request message to the hosting CSE in order to update the <locationPolicy> resource, and transmit a delete request message to the hosting CSE in order to delete the <locationPolicy> resource.

The <locationPolicy> resource generation request message may include the following information.
op: C or CREATE
fr: Identifier of an AE or CSE that generates the request
to: URI of <CSEBase> resource
cn: Representation of the <locationPolicy> resource

A response message to a <locationPolicy> resource generation request can include representation of the generated <locationPolicy> resource and the attribute values specified in Table 1 are set in the representation.

The <locationPolicy> resource retrieve request message may include the following information.
op: R or RETRIEVE
fr Identifier of an AE or CSE that generates the request
to: URI of the <locationPolicy> resource

A response message to a <locationPolicy> resource retrieve request may include the following information.
to: Originator ID
fr: Receiver ID
en: Content of the <locationPolicy> resource

The <locationPolicy> resource update request message may include the following information.
op: U or UPDATE
fr: Identifier of an AE or CSE that generates the request
to: URI or target <locationPolicy> resource
en: Attribute information to be updated

A response message to a <locationPolicy> resource update request may include the following information.
to: Originator ID
fr: Receiver ID
cn: Operation result

The <locationPolicy> resource delete request message may include the following information.
op: D or DELETE
fr: Identifier of an AE or CSE that generates the request
to: URI of target <locationPolicy> resource

A response message to a <locationPolicy> resource delete request may include the following information.
to: Originator ID
fr: Receiver ID
cn: Operation result

A description will be given of a resource in which location information of a (target) terminal is stored. The resource is referred to as <container> in the specification. The <container> resource indicates a container for data instances. The <container> resource is used to share information with other entities and potentially track data. The <container> resource has only attributes and child resources when having no related content. The <container> resource has the following attributes. From among these attributes, attributes having multiplicity including no 0 are mandatory attributes and attributes having multiplicity including 0 are optional attributes.

Location information can be acquired through locationID attribute from among lower attributes of the <container> resource.

TABLE 2

| | | RW/ | |
|---|---|---|---|
| Attribute Name of | | RO/ | |
| <container> | Multiplicity | WO | Description |
| resourceType | 1 | RO | Refer to Table 1 |
| resourceID | 1 | WO | Refer to Table 1 |
| parentID | 1 | RO | Refer to Table 1 |
| expirationTime | 1 | RW | Refer to Table 1 |
| accessControlPolicyIDs | 0 . . . 1 (L) | RW | Refer to Table 1 |
| labels | 0 . . . 1 | RW | Refer to Table 1 |
| creationTime | 1 | RW | Refer to Table 1 |
| creator | 1 | RW | The AE-ID or CSE-ID of the entity |
| | | | which created the resource. |
| lastModifiedTime | 1 | RO | Refer to Table 1 |
| stateTag | 1 | RO | An incremental counter of modification |
| | | | on the resource. When a resource is |
| | | | created, this counter is set to 0, and it |
| | | | will be incremented on every |
| | | | modification of the resource. |
| | | | NOTE: In order to enable detection of |
| | | | overflow, the counter needs to be |
| | | | capable of expressing sufficiently long |
| | | | numbers. |
| | | | NOTE: This attribute has the scope to |
| | | | allow identifying changes in resources |
| | | | within a time interval that is lower than |
| | | | the one supported by the attribute |
| | | | lastModifiedTime (e.g. less than a second |
| | | | or millisecond). This attribute can also |
| | | | be used to avoid race conditions in case |
| | | | of competing modifications. |
| | | | Modifications (e.g. update/delete) can be |
| | | | made on the condition that this attribute |
| | | | has a given value. |
| maxNrOfInstances | 0 . . . 1 | RW | Maximum number of instances of |
| | | | <instance> child resources. |
| maxByteSize | 0 . . . 1 | RW | Maximum number of bytes that are |
| | | | allocated for a <container> resource for |
| | | | all instances in the <container> resource. |
| maxInstanceAge | 0 . . . 1 | RW | Maximum age of the instances of |
| | | | <instance> resources within the |
| | | | <container>. The value is expressed in |
| | | | seconds. |
| currentNrOfInstances | 1 | RO | Current number of instances in a |
| | | | <container> resource. It is limited by the |
| | | | maxNrOfInstances. |
| currentByteSize | 1 | RO | Current size in bytes of data stored in a |
| | | | <container> resource. It is limited by the |
| | | | maxNrOfBytes. |
| latest | 0 . . . 1 | RO | Reference to latest instance, when |
| | | | present. |
| locationID | 0 . . . 1 | RW | URI of the resource where the |
| | | | attributes/policies that define how |
| | | | location information are obtained and |
| | | | managed. This attribute is defined only |
| | | | when the <container> resource is used |
| | | | for containing location information. |
| ontologyRef | 0 . . . 1 | RW | A reference (URI) of the ontology used |
| | | | to represent the information that is stored |
| | | | in the instances of the container. |
| | | | NOTE: the access to this URI is out of |
| | | | scope of oneM2M |
| announceTo | 1 | RW | Refer to Table 1 |

In an M2M system, an access control policy for resources is represented as privileges, in general. Privileges are represented as an entity that can be accessed in a specific access mode. Specifically, a set of privileges may be represented as a group of privileges, which may be represented as the sum of privileges.

The specific access mode can be represented by operations specified in the following table.

TABLE 3

| Operation | Description |
|---|---|
| RETRIEVE | Privilege to retrieve content of a resource to |
| | be accessed |
| CREATE | Privilege to generate a child resource of a |
| | resource to be accessed |
| UPDATE | Privilege to update content of a resource to |
| | be accessed |
| DELETE | Privilege to delete a resource to be accessed |
| DISCOVER | Privilege to discover a specific resource |
| NOTIFY | Privilege to receive a notification message |

The concept of SelfPrivilege refers to a privilege to change the above specified privileges. Privileges specified in an access policy for resources may be values that change according to the range of location or time and IP address. A method of connecting the access policy to a resource includes generating an access policy resource <accessControlPolicy> including access information in the resource and then including link information (URI) of the access policy resource in accessControlPolicyID which is an attribute of the resource to which the access policy is connected. In this manner, the access policy for the specific resource can be set.

The following table shows lower attributes of the access policy resource.

TABLE 4

| | | RW/ | | |
|---|---|---|---|---|
| Attribute Name of | | RO/ | | <accessControlPolicyAnnc> |
| <accessControlPolicy> | Multiplicity | WO | Description | Attribute |
| resourceType | 1 | RO | Refer to Table 1 | NA |
| resourceID | 1 | WO | Refer to Table 1 | MA |
| parented | 1 | RO | Refer to Table 1 | NA |
| expirationTime | 1 | RW | Refer to Table 1 | MA |
| labels | 0 . . . 1 | RW | Refer to Table 1 | MA |
| creationTime | 1 | RO | Refer to Table 1 | NA |
| lastModifiedTime | 1 | RW | Refer to Table 1 | NA |
| announcedTo | 1 | RW | Refer to Table 1 | NA |
| announcedAttribute | 1 | RW | Refer to Table 1 | NA |
| privileges | 1 | RW | Represent a set of access control | MA |
| | | | rules that applies to resources | |
| | | | referencing this | |
| | | | <accessControlPolicy> resource | |
| | | | using the accessControlPolicyID | |
| | | | attribute. | |
| selfPrivileges | 1 | RW | Represent the Set of access | MA |
| | | | control rules that apply to the | |
| | | | <accessControlPolicy> resource | |
| | | | itself | |

The access policy resource <accessControlPolicy> includes common attribute values and additionally includes two attribute values.
Privileges: List of access privileges for connected resources
SelfPrivileges: Access privilege list of the access policy resource

In addition, the privileges and selflPrivileges include the following information.
OriginatorPrivileges: this information specifies an originator of a specific request, which can access the corresponding resource. The corresponding originator can be specified as follows.

TABLE 5

| Name | Description |
|---|---|
| Domain | FQDN domain |
| Originator identifier | CSE-ID or AE-ID indicating the identifier of |
| | the originator |
| Token | Access token that is generally provided as an |
| | inquiry parameter |
| All | All originators |

Contexts: this is a value of a specific condition, to which the access policy for the corresponding resource is applied. This value may be related to location, as described later.
OperationFlags: this specifies an operation value applicable to the corresponding resource. That is, this information can specify at least one of the operations shown in Table 3.

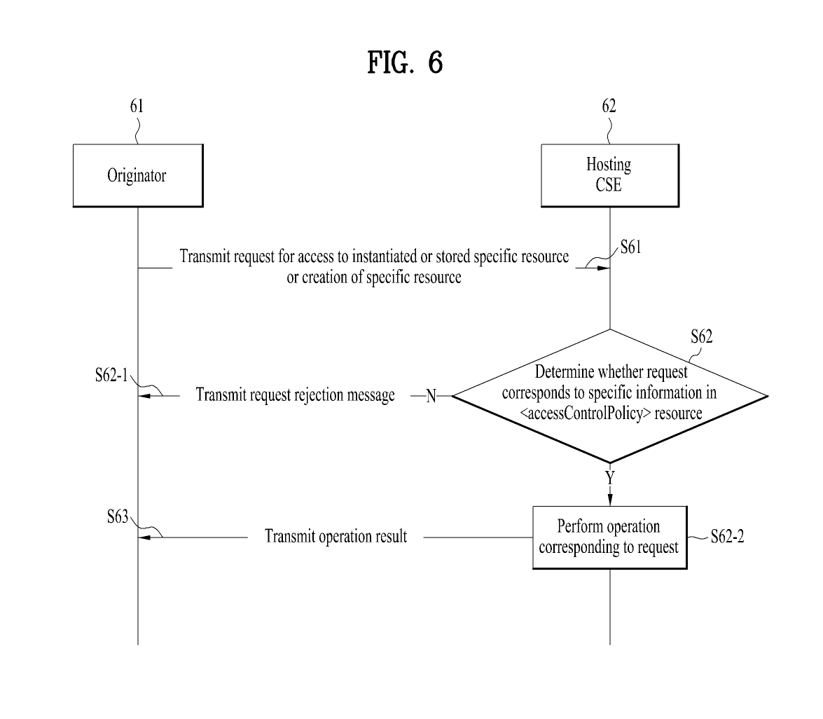

FIG. 6 illustrates the aforementioned resource access policy process.

An originator 61 may transmit, to a hosting CSE 62, a request for accessing an instantiated or stored specific resource or for generation of a specific resource (S61).

The hosting CSE 62 may perform access control for the request (S62). More specifically, the hosting CSE 62 may read originatorPrivileges, contexts and operationFlags included in the privileges attribute specified in <accessControlPolicy> resource and determine whether the request corresponds to the information.

When the request does not correspond to the information, the hosting CSE 62 may transmit a request rejection message to the originator 61 (S62-1). When the request corresponds to the information, the request is permitted and thus the hosting CSE 62 may perform an operation corresponding to the request (S62-2). In addition, the hosting CSE 62 may transmit the result of the operation to the originator 61 (S63).

Conventional resource access methods have various problems. The problems of the conventional resource access methods will now be described.

When requirements for a specific location are specified in the context in the <accessControlPolicy> resource, if a request for accessing a specific resource is generated, then whether access privilege is accepted/permitted is determined according to the location of an originator that requests access to the specific resource.

For example, when temperature information of a device is stored in <tempContainer> the context specifies that only originators located in Seoul can have the privilege to access the corresponding resource.

Accordingly, an originator located in Seoul can access the corresponding resource <tempContainer> and an originator that is not located in Seoul cannot access the corresponding resource.

In this case, however, the following problem is generated due to M2M system structure.

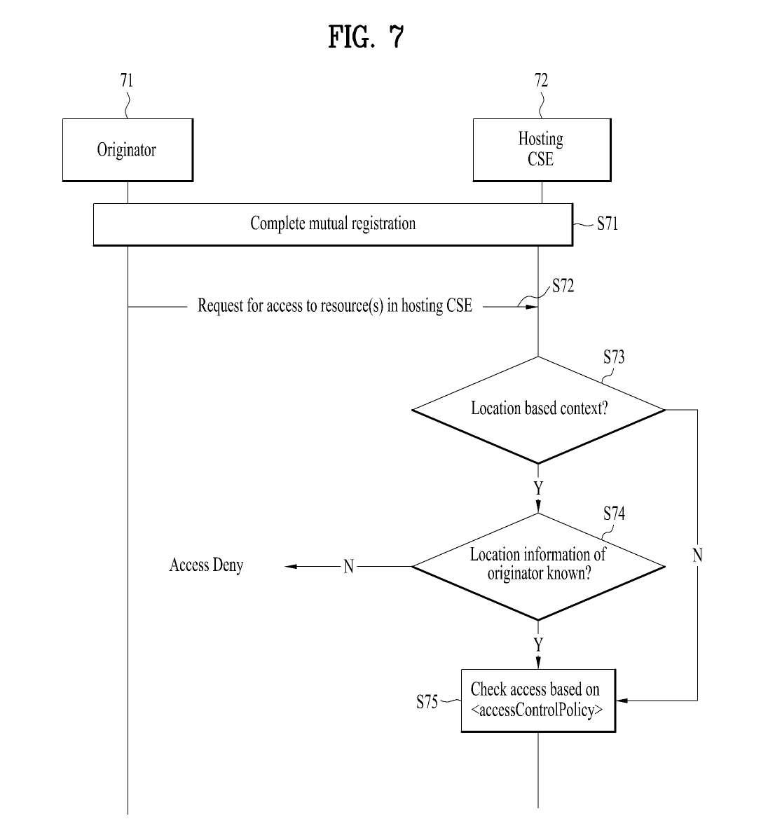

Resource access can be confirmed by the hosting CSE through resource access privilege information specified in the <accessControlPolicy> resource. When the context specifies a specific location, the hosting CSE needs to know the location of an originator that requests resource access. However, the location of the originator is not always provided. This problem is illustrated in FIG. 7.

The originator 71 and the hosting CSE 72 successfully complete mutual registration (S71).

The originator 71 transmits, to the hosting CSE 72, a request for access to a specific resource (S72). The hosting CSE 72 may check the <accessControlPolicy> resource connected to the specific resource to confirm whether the corresponding resource includes a location based context (S73). The process may proceed to step S72 when the corresponding resource includes the location based context and proceed to step S75 when the corresponding resource does not include the location based context.

Then, the hosting CSE 72 may chock whether the hosting CSE 72 knows the location of the originator 71 (S74). When the hosting CSE 72 knows the location of the originator 71, the hosting CSE 72 may check resource access privilege according to location standards in S74. When the hosting CSE 72 is not aware of the location of the originator 71, the hosting CSE 72 may reject the access request of the originator 71. In addition, the hosting CSE 72 may check resource access privilege by checking an originator specified in the <accessControlPolicy> resource and operation that can be performed by the originator (S75).

That is, in the example shown in FIG. 7, location based access control cannot be properly performed when the hosting CSE 72 is not aware of the location of the originator 71.

In addition, when the originator 71 continuously transmits the request for access to the specific resource to the hosting CSE 72 in the example shown in FIG. 7, the hosting CSE 72 has to reject continuous resource access without having a fundamental solution.

Even if the hosting CSE 72 can acquire location information of the originator 71, the hosting CSE 72 needs to acquire the current location of the originator 71 whenever the originator 71 transmits a request to the hosting CSE 72.

Accordingly, the present invention provides a new method for solving the aforementioned problem of the conventional method.

Methods for representing a specific location region according to an embodiment of the present invention include the following two methods.

Circular description: A practical method for describing an area or a region is radius representation. In general, a specific circle is specified by coordinates of the center thereof and the radius thereof. The center and the radius are geographically represented by the longitude and latitude in meters. To this end, accessControlLocationRegions parameter is represented as a circle.

Country description: Another simple method for describing an area or a region is country description. ISO-3166-1 alpha 2 codes are two-character codes for indicating countries and specific areas in which a user is interested.

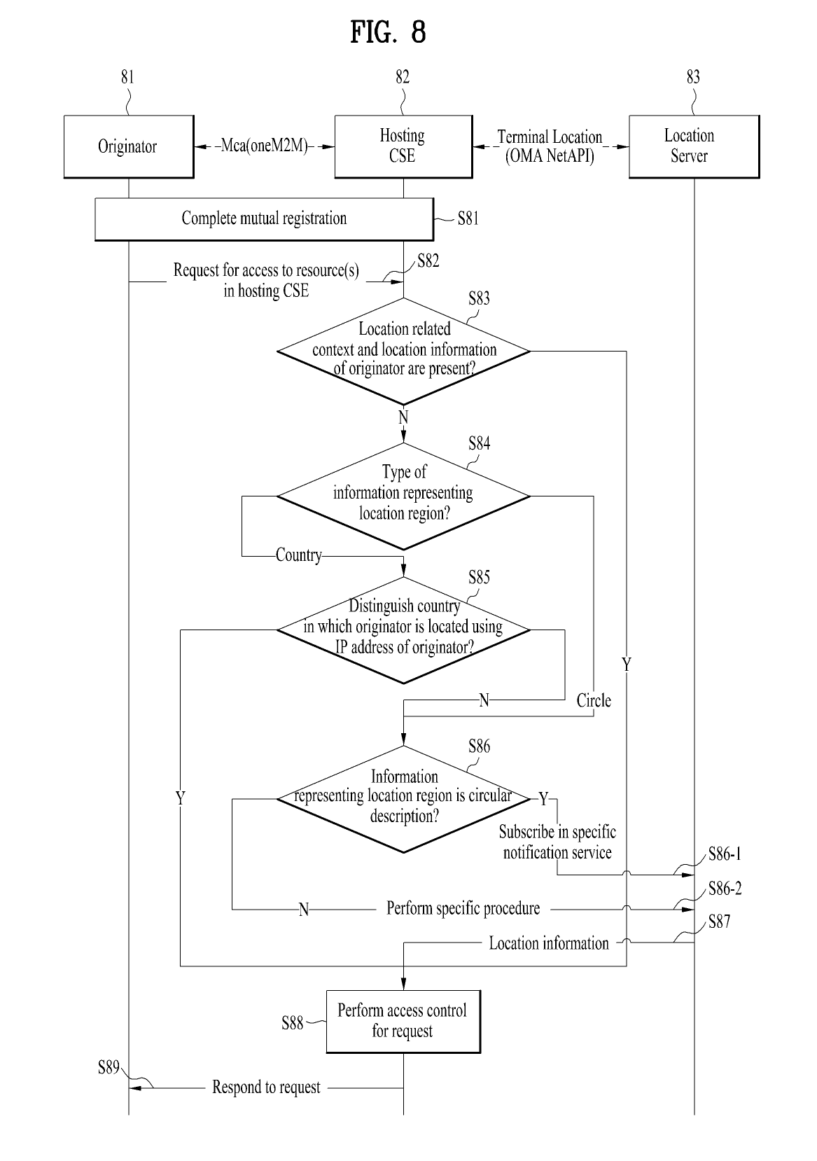

A location based access control method using the aforementioned two methods will now be described with reference to FIG. 8.

An originator 81 and a hosting CSE 82 successfully complete mutual registration (S81).

The originator 81 may transmit, to the hosting CSE 82, a request for access to a specific resource (S82). The request is one of operations (CREATE, RETRIEVE, UPDATE, DELETE) of accessing resources registered with the hosting CSE in an REST (representation state transfer) based system.

The hosting CSE 82 may check the <accessControlPolicy> resource connected to the specific resource and confirm whether the corresponding resource includes information representing the corresponding location region, that is, location related context, and has location information of the originator 81 that requests resource access (S83). The process proceeds to step S89 when the corresponding resource has the location information of the originator 81 and proceeds to step S84 when the corresponding resource does not have the location information of the originator 81.

The hosting CSE 82 may check whether the information representing the location region corresponds to country description or circular description (S84). The process proceeds to step S85 when the information representing the location region corresponds to country description and proceeds to step S86 when the information representing the location region corresponds to circular description.

The hosting CSE 82 may check whether country in which the originator 81 is located can be distinguished using the IP address of the originator 81 (S85). The IP address may be acquired on the basis of IP stack of received packets. Here, even the country of the originator 81 can be confirmed using an IP address DB. The process proceeds to step S89 when country has been distinguished using the IP address and proceeds to step S86 when country has not been distinguished.

Subsequently, the hosting CSE 82 may perform a procedure for acquiring location information of the originator 81. Acquisition of the location information may depend on a method of representing the location region (S86).

When the information representing the location region corresponds to circular description, it is possible to subscribe with a specific location notification service in order to acquire the location information (S86-1). More specifically, the hosting CSE generates <locationPolicy> which sets the following attributes.
locationSource: Network-Based
locationTargetID: Identifier of the originator 81

The hosting CSE 82 may acquire the location of the originator 81 on the basis of circular description specified in <accessControlPolicy>. To check whether a specific entity is located in the corresponding circle on the basis of circular description, the following values are set in <CircleNotificationSubscription> resource defined by OMA (Open Mobile Alliance) Restful NetAPI for Terminal Location standards.
Longitude/latitude/radius: this sets the range of a set area. In the standards, the range of an area is set to a circle only (contents of location context described in <accessControlPolicy> for which the originator requests resource access in step S82 is applied. When the context of <accessControlPolicy> includes location constraint, the value is defined in the form of the corresponding location region.
Frequency and duration: this information is set as an internal policy of the hosting CSE 82.
checkImmediate: When the corresponding value is set to “True”, the hosting CSE can acquire primary location information simultaneously with subscription.

Reference: <CircleNotificationSubscription> Resource in OMA Standards

A protocol of a corresponding message uses the OMA NetAPI (Network Application Programming Interface). The OMA NetAPI can perform region based location information notification by generating resources as follows.

TABLE 6

| Element | Type | Optional | Description |
|---|---|---|---|
| clientCorrelator | xsd:string | Yes | A correlator that the client can use to tag |
| | | | this particular resource representation |
| | | | during a request to create a resource on |
| | | | the server. |
| | | | This element MAY be present. |
| | | | In case the element is present, the server |
| | | | SHALL not alter its value, and SHALL |
| | | | provide it as part of the representation of this |
| | | | resource. In case the element is not present, |
| | | | the server SHALL NOT generate it. |
| resourceURL | xsd:anyURI | Yes | Self referring URL. The resourcesURL |
| | | | SHALL NOT be included in POST requests |
| | | | by the client, but MUST be included in |
| | | | POST requests representing notifications by |
| | | | the server to the client, when a complete |
| | | | representation of the resource is embedded |
| | | | in the notification. |
| | | | The resourceURL MUST also be included in |
| | | | responses to any HTTP method that returns |
| | | | an entity body, and in PUT requests. |
| link | common:Link[0 . . . unbounded] | Yes | Link to other resources that are in |
| | | | relationship with the resource. |
| callbackReference | common:CallbackReference | No | Notification callback definition. |
| requester | xsd:anyURI | Yes | It identifies the entity that is requesting the |
| | | | information (e.g., ‘sip’ URI, ‘tel’ URI, ‘acr’ |
| | | | URI). |
| | | | The application invokes this operation on |
| | | | behalf of this entity. However, it does not |
| | | | imply that the application has authenticated |
| | | | the requester. |
| | | | If this element is not present, the requesting |
| | | | entity is the application itself. |
| | | | If this element is present, and the requester |
| | | | is not authorized to retrieve location info, a |
| | | | policy exception will be returned. |
| address | xsd:anyURI [1 . . . unbounded] | | Addresses of terminals to monitor (e.g., ‘sip’ |
| | | | URI, ‘tel’ URI, ‘acr’ URI). Reference to a |
| | | | group could be provided here if supported |
| | | | by implementation. |
| latitude | xsd:float | | Latitude of center point. |
| longitude | xsd:float | | Longitude of center point. |
| radius | xsd:float | | Radius of circle around center point in |
| | | | meters. |
| trackingAccuracy | xsd:float | | Number of meters of acceptable error in |
| | | | tracking distance. |
| enteringLeavingCriteria | | | Indicates whether the notification should |
| | | | occur when the terminal enters or leaves the |
| | | | target area. |
| checkImmediate | xsd:Boolean | | Check location immediately after |
| | | | establishing notification. |
| frequency | xsd:int | | Maximum frequency (in seconds) of |
| | | | notifications per subscription (can also be |
| | | | considered minimum time between |
| | | | notifications). |
| duration | xsd:int | | Period of time (in seconds) notifications are |
| | | | provided for. If set to “0” (zero), a default |
| | | | duration time, which is specified by the |
| | | | service policy, will be used. If the parameter |
| | | | is omitted, the notifications will continue |
| | | | until the maximum duration time, which is |
| | | | specified by the service policy, unless the |
| | | | notifications are stopped by deletion of |
| | | | subscription for notifications. |
| count | xsd:int | | Maximum number of notifications per |
| | | | individual address. For no maximum, either |
| | | | do not include this element or specify a |
| | | | value of zero. Default value is 0. |

When the information representing the location region is country description, the hosting CSE 82 may perform a specific procedure for acquiring the location information (S86-2). More specifically, the hosting CSE 82 may generate <locationPolicy>. The hosting CSE 82 may set the following lower two attributes.
locationSource: Network-Based
locationTargetID: Identifier of the originator 81

The hosting CSE 82 may use <TerminalLocation> resource defined by OMA Restful NetAPI for Terminal Location standards in order to acquire a location coordinate value of the originator 81. This will now be briefly described.

The hosting CSE 92 may transmit, to a location server 83, a request for locations of one or more terminals including the originator 81. The request may include request URIs including terminal addresses and a location server address. The request may include the following attributes.

TABLE 7

| | OMA NetAPI | | |
|---|---|---|---|
| Attributes | Defined Type | Description | Relevant Attribute |
| Address | xsd:anyURI | Address of the terminal to | locationTargetID in the |
| | | which the location information | <locationPolicy> resource |
| | | applies | type |
| locationRetrievalStatus | common: | Status of retrieval for this | locationStatus in the |
| | RetrievalStatus | terminal address. | <locationPolicy> resource |
| | | | type |
| currentLocation | LocationInfo | Location of terminal. | Content in the |
| | | | <contentInstance> |
| | | | resource type |

The location server may retrieve the location information of one or more terminals including the originator 81 in response to the request. Upon successful retrieval, the location server may transmit, to the hosting CSE 82, locations of the one or more terminals including the originator 81.

When <CircleNotificationSubscription> is set according to S86-1, the location server may acquire the location of the originator 81 and transmit information on the location to the hosting CSE 82 (S87). Alternatively, the location server may transmit the information on the location of the originator 81 to the hosting CSE 82 according to S86-2 (S87).

The hosting CSE 82 may perform access control for the request for access to the specific resource using the information on the location of the originator (S88). For example, the hosting CSE 82 can determine whether the location of the originator satisfies the location related context of the <accessControlPolicy> resource.

The hosting CSE 82 may transmit a response to the request to the originator 81 according to whether the location of the originator satisfies the location related context (S89). When the location of the originator satisfies the location related context, the hosting CSE 82 may transmit a “grant” message for the request to the originator 81. When the location of the originator does not satisfy the location related context, the hosting CSE 82 may transmit a “deny” message for the request to the originator 81.

According to an embodiment of the present invention, location based access control can be successfully performed by matching the location related context specified in the <accessControlPolicy> resource to location information provided by the location server. Particularly, when CircleNotificationSubscription function is used, the hosting CSE 82 can perform location based access control by acquiring the location of the originator even if the hosting CSE 82 does not request new location information whenever the originator requests resource access.

When the hosting CSE 82 is configured to be notified of the location of the originator 81 according to S86-1, the location server 83 may notify the hosting CSE 82 of location change of the originator 81 when the originator 81 enters or leaves the region (i.e. region according to circular description). Accordingly, the hosting CSE 82 can track the location of the originator and easily evaluate constraints according to the location related context.

FIG. 14 is a block diagram of a transmitting device 10 and a receiving device 20 configured to implement exemplary embodiments of the present invention. Referring to FIG. 14, the transmitting device 10 and the receiving device 20 respectively include radio frequency (RF) units 13 and 23 for transmitting and receiving radio signals carrying information, data, signals, and/or messages, memories 12 and 22 for storing information related to communication in a wireless communication system, and processors 11 and 21 connected operationally to the RF units 13 and 23 and the memories 12 and 22 and configured to control the memories 12 and 22 and/or the RF units 13 and 23 so as to perform at least one of the above-described embodiments of the present invention.

The memories 12 and 22 may store programs for processing and control of the processors 11 and 21 and may temporarily storing input/output information. The memories 12 and 22 may be used as buffers.

The processors 11 and 21 control the overall operation of various modules in the transmitting device 10 or the receiving device 20. The processors 11 and 21 may perform various control functions to implement the present invention. The processors 11 and 21 may be controllers, microcontrollers, microprocessors, or microcomputers. The processors 11 and 21 may be implemented by hardware, firmware, software, or a combination thereof. In a hardware configuration, Application Specific Integrated Circuits (ASICs), Digital Signal Processors (DSPs), Digital Signal Processing Devices (DSPDs), Programmable Logic Devices (PLDs), or Field Programmable Gate Arrays (PPGAs) may be included in the processors 11 and 21. If the present invention is implemented using firmware or software, firmware or software may be configured to include modules, procedures, functions, etc. performing the functions or operations of the present invention. Firmware or software configured to perform the present invention may be included in the processors 11 and 21 or stored in the memories 12 and 22 so as to be driven by the processors 11 and 21.

In the embodiments of the present invention, application (entity) or resource related entity etc. may operate as devices in which they are installed or mounted, that is, a transmitting device 10 or a receiving device 20.

The specific features of the application (entity) or the resource related entity etc. such as the transmitting device or the receiving device may be implemented as a combination of one or more embodiments of the present invention described above in connection with the drawings.

The detailed description of the exemplary embodiments of the present invention has been given to enable those skilled in the art to implement and practice the invention. Although the invention has been described with reference to the exemplary embodiments, those skilled in the art will appreciate that various modifications and variations can be made in the present invention without departing from the spirit or scope of the invention described in the appended claims. Accordingly, the invention should not be limited to the specific embodiments described herein, but should be accorded the broadest scope consistent with the principles and novel features disclosed herein.

### INDUSTRIAL APPLICABILITY

The present invention may be used for a wireless communication apparatus such as a terminal, a base station, a server, or other apparatuses.

What is claimed is:

1. A method for location based access control in a wireless communication system, comprising:
receiving, from an originating device, a request for access to a specific resource associated with location constraints, the location constraints being related to circular description or country description;
checking whether location information of the originating device is present;
acquiring the location information of the originating device according to type of the location constraints when the location information of the originating device is not present; and
performing access control based on the acquired location information,
wherein the acquiring of the location information of the originating device comprises:
acquiring the location information of the originating device by subscribing to a location notification service toward a location server when the location constraints are related to the circular description;
determining whether country in which the originating device is located is distinguished using an Internet protocol (IP) address of the originating device when the location constraints are related to the country description; and
acquiring the location information of the originating device by requesting the location server to provide the location information of the originating device when the country is not distinguished using the IP address of the originating device.

2. The method according to claim 1, wherein the acquiring the location information of the originating device by subscribing to the location notification service toward the location server comprises:
setting a value corresponding to the circular description in a resource related to the location notification service; and
receiving information on the location of the originating device according to the location notification service.

3. The method according to claim 1, wherein the acquiring the location information of the originating device by subscribing to the location notification service toward the location server comprises receiving a notification of location change of the originating device from the location server when the originating device enters or leaves a region corresponding to the circular description.

4. The method according to claim 1, wherein the performing access control based on the acquired location information comprises:
checking whether the acquired location information satisfies the location constraints; and
transmitting a response to the request for access according to a result of the checking to the originating device.

5. The method according to claim 1, wherein the location constraints are included in a specific parameter in <accessControlPolicy> resource associated with the specific resource.

6. An apparatus configured to perform location based access control in a wireless communication system, comprising:
a radio frequency (RF) unit; and
a processor configured to control the RF unit,
wherein the processor is configured: to receive, from an originating device, a request for access to a specific resource associated with location constraints, the location constraints being related to circular description or country description; to check whether location information of the originating device is present; to acquire the location information of the originating device according to type of the location constraints when the location information of the originating device is not present; and to perform access control based on the acquired location information,
wherein the process is configured: to acquire the location information of the originating device by subscribing to a location notification service toward a location server when the location constraints are related to the circular description; to determine whether country in which the originating device is located is distinguished using an Internet protocol (IP) address of the originating device when the location constraints are related to the country description: and to acquire the location information of the originating device by requesting the location server to provide the location information of the originating device when the country is not distinguished using the IP address of the originating device.

7. The apparatus according to claim 6, wherein the processor is configured to set a value corresponding to the circular description in a resource related to the location notification service and to receive information on the location of the originating device according to the location notification service to acquire the location information of the originating device by subscribing to the location notification service toward the location server.

8. The apparatus according to claim 6, wherein the processor is configured to receive a notification of location change of the originating device from the location server when the originating device enters or leaves a region corresponding to the circular description to acquire the location information of the originating device by subscribing to the location notification service toward the location server.

9. The apparatus according to claim 6, wherein the processor is configured to check whether the acquired location information satisfies the location constraints and to transmit a response to the request for access according to a result of the checking to the originating device to perform access control based on the acquired location information.

10. The apparatus according to claim 6, wherein the location constraints are included in a specific parameter in <accessControlPolicy> resource associated with the specific resource.
